(19) United States
(12) Patent Application Publication
(10) Pub. No.: US 2026/0180490 A1
(43) Pub. Date: Jun. 25, 2026

(54) LOCKING SYSTEM FOR PHOTOVOLTAIC MODULES WITH CONSTRAINT ON THE LONGER SIDE

(71) Applicant: CONTACT ITALIA S.R.L., Altamura (BA) (IT)

(72) Inventor: Francesco Maggi, Altamura (BA) (IT)

(73) Assignee: CONTACT ITALIA S.R.L., Altamura (BA) (IT)

(21) Appl. No.: 19/124,992

(22) PCT Filed: Oct. 12, 2023
(86) PCT No.: PCT/IB2023/060288

§ 371 Date: Apr. 28, 2025

(30) Foreign Application Priority Data
Oct. 28, 2022 (IT) 102022000022311

(51) Int. Cl. H02S 20/00; F24S 25/61; F24S 25/632; F24S 25/65; F24S 25/67; F24S 25/70; H02S 20/23; H02S 30/10

(52) U.S. Cl. CPC H02S 20/00; F24S 25/61; F24S 25/632; F24S 25/65; F24S 25/67; F24S 25/70; H02S 20/23; H02S 30/10

(57) ABSTRACT

A locking system for large photovoltaic modules which overcomes the limits linked to the manufacturing methods by means of constraints on their longer side; the system comprising blocks in cement conglomerate, to guarantee greater stability to the module itself and to allow the distance between the locking points to be varied both for horizontal panel installations and for vertical panel installations.

### RELATED APPLICATIONS

This is a national stage application of PCT/IB2023/060288 application having an international filing Date of 12 Oct. 2023. This application claims foreign priority based on application No. 102022000022311 of Italy, filed on 28 Oct. 2022.

### BACKGROUND OF THE INVENTION

### 1. Field of the Invention

The present invention concerns a locking system for photovoltaic modules by means of constraint on their longer side, the system comprising blocks in cement conglomerate.

### 2. Brief Description of the Prior Art

Various ways of creating locking systems for photovoltaic modules with pre-assembled supports, made of different materials such as aluminium, steel and concrete, are known in the state of the art.

Supports made with aluminum profiles require long installation times, since they do not arrive completely assembled on site and require a pre-assembly phase. When installing the photovoltaic modules, these supports make the choice of both the module orientation and the frame thickness less versatile. Furthermore, with these assembly kits, the size of the support center distance is not pre-established but varies depending on the loading conditions present on the site, and consequently the position and quantity of the necessary ballasts is not univocally determined either. Since the load of the ballast blocks is not always uniformly distributed on the roof, particularly in those cases where it is necessary to position the supports at high distances between centres, problems of a structural nature linked to load concentrations on the roof may arise.

In particular, in recent years, the study of innovative technologies has allowed the production of new generation photovoltaic modules, having larger dimensions than ordinary or “standard” photovoltaic modules, which therefore occupy a larger installation surface.

There is therefore a need to adapt locking systems to these new generation photovoltaic modules.

In particular, with such large panels it is often necessary to comply with the requirements provided by the manufacturer regarding the position of the locking points, requirements which vary for each model of photovoltaic panel.

### SUMMARY OF THE INVENTION

The aim of the present invention is therefore to provide a locking system for large photovoltaic modules which overcomes the limits linked to the manufacturing methods known to the state of the art.

In particular, the aim is to provide a locking system for photovoltaic modules that allows the constraint on their longer side in order to guarantee greater stability to the module itself.

Furthermore, the aim of the present invention is to provide a locking system for photovoltaic modules which allows the distance between the locking points to be varied both for horizontal panel installations and for vertical panel installations.

Therefore, according to one aspect of the present invention, a locking system for photovoltaic modules is provided having the characteristics set out in the independent product claim, attached to the present description.

Further embodiments of the invention, preferred and/or particularly advantageous, are described according to the characteristics set out in the attached dependent claims.

### BRIEF DESCRIPTION OF THE DRAWINGS

The invention will now be described with reference to the attached drawings, which illustrate a non-limiting example of implementation, in which:

FIG. 1 is an axonometric view of the locking system for photovoltaic modules horizontally, i.e. inclined along the direction of the shorter side, according to a first embodiment of the present invention,

FIG. 2 is a detail of the connection of the module to a profile along the longitudinal direction of the module by means of suitable clamps,

FIG. 3 is a detail of the connection of the module to a profile along the transversal direction of the module by means of suitable clamps,

FIG. 4 is a side view of the photovoltaic module system of FIG. 1,

FIG. 5 is a side installation view of the system according to FIG. 1,

FIG. 6 is an axonometric view of the locking system for vertical photovoltaic modules, i.e. inclined according to the direction of the longer side, according to a further embodiment of the present invention,

FIG. 7 is a detail of the connection of the module to a profile along the transversal direction of the module by means of suitable clamps,

FIG. 8 is a detail of the connection of the module to a profile along the longitudinal direction of the module by means of suitable clamps,

FIG. 9 is a side installation view of the system according to FIG. 6.

### DETAILED DESCRIPTION OF THE PREFERRED EMBODIMENTS

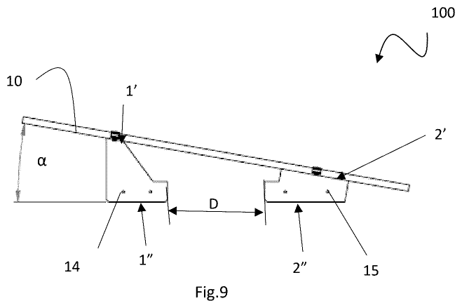

The invention is described in detail below, with reference to the attached FIGS. 1-9. The locking system 100 for photovoltaic modules includes at least two pairs of blocks or ballasts 1, 2 in cement conglomerate.

Both blocks 1,2 have a prismatic shape with an upper surface 1′ 2′ and a lower surface 1″, 2″. Furthermore, the upper surfaces 1′, 2′ have the same inclination a pre-established in the project for the photovoltaic modules while the lower surfaces 2′, 2″ have the same position as the support surface. In the first block 1 the minimum distance D1 between the upper surface 1′ and the lower surface 1″ is greater than the minimum distance D2 between the upper surface 2′ and the lower surface 2″ of the second block 2.

Therefore, the lower surfaces 1″, 2″ are configured in such a way as to allow a stable support on a flat roof of the blocks 1, 2, while the upper surfaces 1′, 2′ are configured in such a way as to allow the support of a photovoltaic module 10 to be mounted with an inclination a with respect to the roof.

In particular, the locking system 100 described is suitable for large photovoltaic modules, where it is above all the larger side that has a larger dimension than that of standard modules.

The pairs of blocks 1, 2 according to the invention, allow a photovoltaic module 10 to be supported and fixed on four support points, each pair of blocks 1,2 always being positioned along the longer side of the module 10, at a pre-established distance from the corresponding end of module 10, so as to guarantee its stability.

Conveniently, the internal distance D between the first block 1 and the second block 2 is predetermined so as to guarantee coplanarity between the blocks and the correct assembly of the photovoltaic modules. Even more conveniently, the same functionality can be achieved with different inclinations of the blocks.

Furthermore, the same geometry of blocks 1, 2 allows the assembly of photovoltaic modules of different sizes: length of the shorter side between 990 mm and 1350 mm and length of the longer side up to 2300 mm.

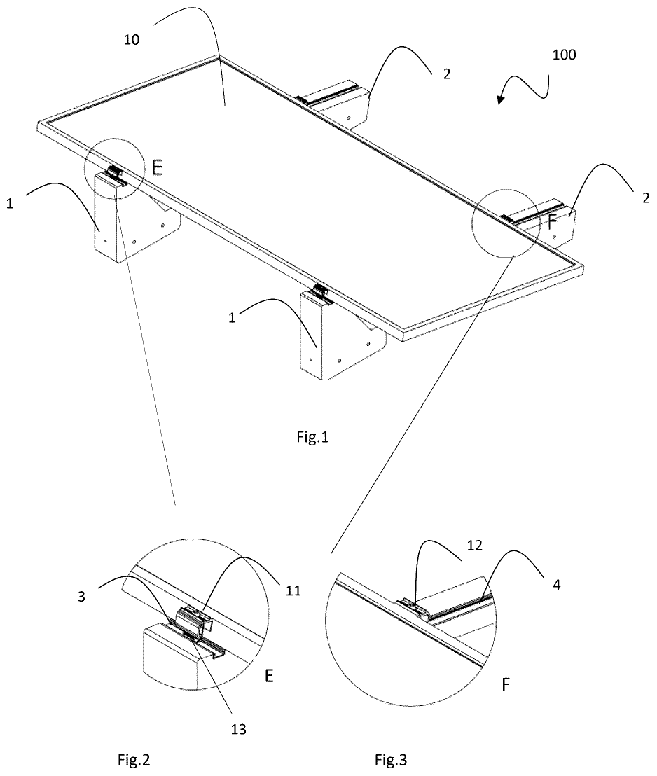

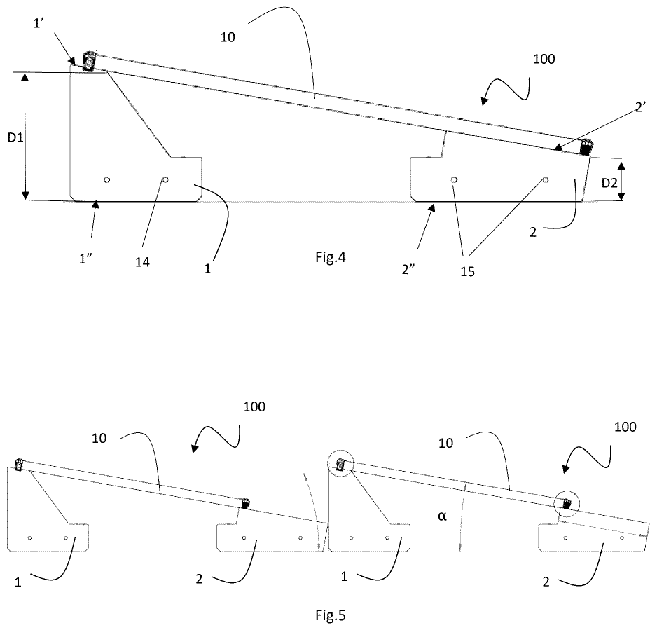

According to a first configuration, illustrated in FIG. 1, the locking system allows the installation of photovoltaic modules arranged horizontally, i.e. inclined along the direction of the shorter side, and has block 1 and block 2 which correspond to each other along the direction of the smaller side of the photovoltaic module 10. In particular, as shown in the details of FIGS. 2 and 3, along the upper surface 1′ of the first block 1 there is a metal profile 3 with a “C” shape which, in operation, develops in longitudinal direction with respect to the longer side of the photovoltaic module 10 and along the upper surface 2′ of the second block 2 there is a metal profile 4 with a “C” shape which, when installed, develops in a transversal direction with respect to the longer side of the photovoltaic module 10.

In a second configuration, illustrated in FIG. 6, the locking system allows photovoltaic modules to be installed vertically, i.e. inclined along the direction of the longer side, and has block 1 and block 2 which correspond to each other along the direction of the longer side. larger than the photovoltaic module 10. In particular, as shown in the details of FIGS. 7 and 8 along the upper surface 1′ of the first block 1 there is a metal profile 3 with a “C” shape which, in operation, develops in the direction transversally with respect to the one joining the first 1 and the second block 2 and along the upper surface 2′ of the second block 2 there is a metal profile 4 which, in operation, develops in a longitudinal direction with respect to the one joining the first 1 and the second block 2.

Regardless of the chosen configuration, the connection of the module 10 to the metal profiles 3, 4 can conveniently take place by means of suitable clamps 11, 12. Preferably said metal profiles 3, 4 are made of aluminium. It is specified that, as evident from the analysis of FIGS. 6, 7 and 8, the clamps 11, 12 slide along the respective profiles 3,4.

Since the profiles 3 of the first block 1 develop along the direction transversal to the longer side of the panel, and the profiles 4 of the second block 2 develop along the longitudinal direction with respect to the longer side of the panel, the presence of clamps sliding along the profiles allows to vary the distance between the two locking points of the panel both with vertical and horizontal mounting. This allows you to comply with the requirements on the distance of the clamping points which are different for each panel model.

Conveniently, inside the metal profiles 3, 4 it is possible to mount the same type of universal clamps 11, 12. The core 13 of the clamp is inserted inside the metal profile 3,4, between the two wings of the “C”, while the upper portion of this clamp 11, 12 is configured to rotate and assume any orientation between 0° and 360° depending on the vertical or horizontal orientation of the module 10. The versatility of each block 1, 2 allows the photovoltaic module to be mounted in both horizontal and vertical orientation with a pre-established inclination a.

Therefore, the position of the metal profiles 3, 4 and the clamps 11, 12 is such that the photovoltaic module 10, once installed, is stably anchored along its longer sides to said blocks 1, 2 in cement conglomerate, according to the inclination pre-established.

According to a preferential embodiment, each block 1, 2 also includes, on its lateral surface, a pair of lateral through holes 14,15 to allow the assembly of brace bars in both the transverse and longitudinal directions: in the transverse direction with the insertion of round bars, in longitudinal direction with use of box profiles anchored to the ballast with dowels. Each block has a bushing (embedded in the concrete) both on the rear part to allow the assembly of brace bars, and on the upper part of the step to allow the possible assembly of a profile connecting the two blocks (front and rear).

Having described the blocks, it is now described how they are used. To install a row of photovoltaic modules, it will be sufficient to place a sufficient number of blocks side by side to support all the modules provided, taking care to position the blocks at a distance between centers equal to the size of the module. Once the blocks have been positioned, to install the modules it is sufficient to position the modules and tighten the clamps.

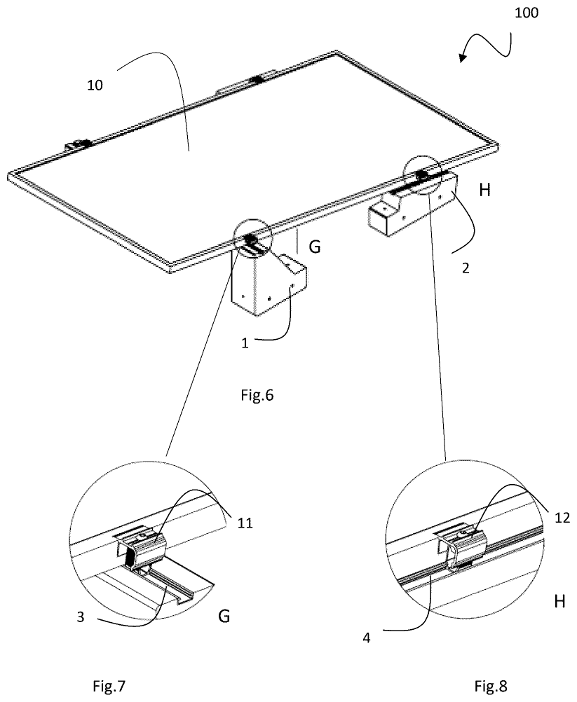

As shown in FIG. 5, the modularity of each system allows the installation of contiguous modules aligned with each other and arranged in a pre-established orientation.

The presence of structural fibers of polymeric material in the cement conglomerate increases the load-bearing capacity, toughness and ductility in the shear behavior of the concrete, limiting the cracking phenomenon: the cement conglomerate in fact has a residual resistance after a possible start of crack propagation. The use of fibers also represents a secondary reinforcement and also concomitant to a possible presence of primary structural reinforcement due to the possible use of iron rods embedded in the concrete block. The combination of the two types of structural reinforcement reduces the risk of brittle fracture by increasing the resistance of the entire block to fatigue, impacts and thermal stress. Lastly, the presence of polymer fibers also reduces corrosion problems, lowering the maintenance costs of the entire photovoltaic system.

In addition to the embodiments of the invention, as described above, it should be understood that numerous other variations exist. It should also be understood that such embodiments are exemplary only and do not limit either the scope of the invention, its applications, or its possible configurations. On the contrary, although the above description allows the specialized technician to implement the present invention at least according to one of its exemplary embodiments, it must be understood that many variations of the described components are possible, without thereby departing from the scope of the invention, as defined in the attached claims.

1. A locking system (100) for a photovoltaic module (10) comprising at least two pairs of concrete blocks (1, 2), each block (1, 2) of each pair having:
an upper surface (1′, 2′) having an inclination (α) and configured in such a way as to allow the support of the photovoltaic module (10), which must have the same inclination (α) on site and
a lower surface (1″, 2″) configured in such a way as to allow a stable support on a flat surface,
said upper surface (1′, 2′) also comprising a metal profile (3, 4) configured to allow photovoltaic module (10) connection to the blocks (1, 2) by means of clamps (11, 12)
wherein along the upper surface (1′) of the first block (1) a metal profile (3) is provided, positioned in a transversal direction with respect to the direction joining said first block (1) and second block (2) when installed on site and along the upper surface (2′) of the second block (2) a metal profile (4) is provided positioned in a longitudinal direction with respect to the direction joining said first (1) and second block (2) when installed on site.

2. The locking system (100) for photovoltaic modules according to claim 1, wherein the metal profile (3, 4) is configured to slidingly couple the core (13) of said clamp (11, 12), and by the fact that the upper portion of said clamp (11, 12) is configured to rotate from 0° to 360° around an axis perpendicular to said upper surface (1′, 2′).

3. The locking system (100) according to claim 1, wherein each block (1, 2) of each pair of blocks is positioned along the longer side of the photovoltaic module (10).

4. The locking system (100) according claim 1, wherein the first block (1) has a minimum distance (D1) between the upper surface (1′) and the lower surface (1″) greater than a minimum distance (D2) between the upper surface (2′) and the lower surface (2″) of a second block (2).

5. The locking system (100) according to claim 1, wherein the photovoltaic module (10) is inclined along the direction of the shorter side and the block (1) and the block (2) correspond to each other along the direction of the side smaller than the photovoltaic module (10).

6. The locking system (100) according to claim 1, wherein the photovoltaic module (10) is inclined along the direction of the longer side and the first block (1) and the second block (2) correspond to each other along the direction of the longer side of the photovoltaic module (10).

7. The locking system (100) for photovoltaic modules according to claim 1, wherein the internal distance between said first block (1) and second block (2) is such that, in operation, said blocks (1, 2) are at a predetermined distance (D).

8. The locking system (100) for photovoltaic modules according to claim 1, wherein each of said concrete blocks (1, 2) further comprises, on its lateral surface, a pair of through holes (14, 15) to allow the mounting of round bars in order to make a rigid connection between different blocks.
